(19) United States
(12) Patent Application Publication
(10) Pub. No.: US 2022/0400708 A1
(43) Pub. Date: Dec. 22, 2022

(54) FLAVOURED EFFERVESCENT TABLET FOR THE PREPARATION OF INSTANT BEVERAGES AND PRODUCTION METHOD

(71) Applicant: Carlos Roberto ROSADO VALENZUELA, Zapopan (MX)

(72) Inventors: Carlos Roberto ROSADO VALENZUELA, Zapopan (MX); Carlos Roberto ROSADO PACHECO, Zapopan (MX)

(21) Appl. No.: 17/776,473

(22) PCT Filed: Nov. 13, 2019
(86) PCT No.: PCT/MX2019/000124

§ 371 Date: May 12, 2022

(30) Foreign Application Priority Data
Nov. 12, 2019 (MX) MX/A/2019/013539

(51) Int. Cl. A23L 2/40; A23L 2/395; A23L 2/60

(52) U.S. Cl. CPC A23L 2/40; A23L 2/395; A23L 2/60; A23V 2002/00

(57) ABSTRACT

The invention relates to a flavored effervescent tablet for the preparation of instant beverages for human consumption, which comprises: sugar, maltodextrin, citric acid, sodium bicarbonate, ascorbic acid and sorbitol. The invention also relates to a production method comprising pressing the mixture of all the ingredients into molds.

### FIELD OF THE INVENTION

The present invention relates to the field of chemistry, specifically to a non-alcoholic tablet that contains all the flavor profiles for preparing a beverage with specific flavors.

### BACKGROUND OF THE INVENTION

When discussing cocktail making, this is understood as the “art of preparing cocktails” and when discussing a cocktail, this relates to a “beverage made up of liquors to which other ingredients have usually been added.” In general, a preparation based on a mixture of different beverages which normally includes one or more types of alcoholic beverages is defined as a cocktail, but mixtures may exist without alcohol and these are also known as cocktails.

The art of mixing ingredients and creating beverages for medicinal purposes goes back to the fourth century before the common era, known as the century of Alexander the Great, when it is thought that already a profusion of these types of preparations were produced.

In 1862, the strongest evidence is found with the publication of How to mix drinks by Jerry Thomas. This guide for bartenders presented a wealth of recipes of all types and ten recipes for “cocktails,” described as a mixture of beverages in which bitter flavors were used.

Cocktails as such began to become popular in the United States towards the end of the 19th century and have lasted to the present day. In the 20th century said cocktails became a symbol of distinction, fashionable places in North America and Europe began to serve large numbers of creations, and various global wars and American contingents helped spread them still further.

Moreover, for the instant preparation of flavored beverages in the prior art, the market for powdered beverages is one of the most dynamic sectors of recent years within the food industry as regards variety of flavors and new product launches. In addition, it is also one of the sectors that has contributed most in terms of the technology used both in the product per se and in the variety of presentations.

Powdered beverages may be defined generally as a mixture of micro and macro ingredients balanced so that when dissolved in a liquid they provide flavor, color, texture and turbidity, if required. All this contained in convenient presentations that allow the use thereof in the place and at the time the consumer wishes, allowing a refreshing beverage to be enjoyed as said consumer pleases.

These powdered beverages have a series of advantages with respect to ready-to-drink beverages, such as:
a) The presentation thereof allows storage in a small space, whether in the home or on the shelves of supermarkets and convenience stores,
b) They are easy to carry and prepare,
c) They allow the consumer to adjust the sugar levels of the product entirely to taste,
d) Instant powdered beverages exist at present that are prepared based on sugar, non-nutritive sweeteners or a mixture of both, which allows the consumer to decide which product is best adapted to their dietary or health needs,
e) Powdered beverages provide the consumer with a wide range of options as to flavors, prices and presentations,
f) This sector has made incursions into the market not only for soft drinks but also hot beverages using milk or hot water as diluents to obtain coffee-based or tea-based (black or green) beverages,
g) Finally, energizing and fortified powdered beverages can be found for the sections of the population demanding said beverages.

In the development of a powdered beverage, an entire series of technologies is used to prepare each and every one of the ingredients that forms part of a final formulation:
Sweeteners:
   a) Cane sugar: this natural sweetener was and continues to be one of the most commonly used due to its availability, price and characteristic sweetness which is very similar to the sweetness provided by a beverage based on natural fruits.
   b) Powdered fructose: found naturally in fruits, its presentation as a powder makes it attractive to those sections of the population that tend to favor natural products.
   c) Non-nutritive sweeteners with a low calorie content: this type of ingredient emerged a few years ago and has been widely accepted by those sections of the population that are interested in their health and appearance. These products have a sweetening power that is hundreds of times greater than cane sugar, so that only a few milligrams are needed to sweeten a liter of beverage. The mere use of this type of ingredient changes the presentations of powdered beverages with a low calorie content. The most widely used are acesulfame K and aspartame. The only drawback of using these sweeteners is that they have a characteristic aftertaste which is unpleasant for some consumers.
   d) Some powdered beverages mix natural and non-nutritive sweeteners to produce a “hybrid” beverage that sweetens in a similar way to that found in beverages based on natural fruits.
Colorants:
   Both natural and artificial colorants, or a mixture of both, may be used. The secret of using these types of ingredients is knowing how to develop said colorants to provide color to the powdered product as well as to the prepared beverage, although use may also be made of aluminum lacquers to obtain a more homogeneous appearance. The most widely used artificial colorants in these types of products are Yellow 5 (tartrazine), Yellow 6 (sunset yellow), Red 40 (carmoisine) and Blue 1 (brilliant blue).
Thickeners:
   Like non-nutritive sweeteners, thickeners are added in very small amounts. A developer of powdered beverages has the advantage of having numerous thickeners to hand with which different characteristics are obtained, coming from very diverse sources and that may or may not provide soluble fiber, which is considered an added value in the final product. These include guar gum and carboxymethylcellulose.
Flavorings:
   The flavorings used in the development of powdered beverages must by spray-dried flavoring agents because by using this technology, not only is the stability of the end product assured, but the shelf life of the powdered beverage is extended and the risk of oxidation is minimized if the flavoring is developed on the basis of essential citrus oils.
Anti-caking agents:
   The use of these ingredients becomes necessary particularly when the intention is to market the powdered beverages in areas with high relative humidity or when there is no suitable packaging to protect said beverages from interacting with the environmental humidity. The immediate effect of not using anti-caking agents in a product that is subject to the above-mentioned conditions is compaction and hence a shorter shelf life. The most commonly used are silicon dioxide and tricalcium phosphate.

The invention that has been developed began with observing and studying the complexity and time taken to make prepared beverages, such as cocktails, and as well as reducing costs, to make it possible for anyone to prepare complex beverages as easily as possible with no room for errors, and also to increase the places and circumstances in which a person is able to prepare a complex beverage with no knowledge whatsoever.

Based on an analysis of documents of the prior art, inventions exist that attempt to solve similar problems, as is the case of the invention described in document WO2005021056A1 which relates to equipment and a method for delivering vapor from an effervescent material. The invention described includes a housing and a pouch which contains an effervescent material. The effervescent chemical composition includes an exothermic reaction system and a fragrant material impregnated into an absorbent material. When water is added to the reactant system, this generates heat and the fragrant material becomes volatile, which releases the fragrance. The container includes one or more openings to allow water to reach the reactant system and also includes one or more raised ridges in order to dispense heat in such a way that the container can be handled while the reactant system is releasing heat.

Another invention that attempts to solve the problem is described in document U.S. Pat. No. 8,114,457B2 which relates to beverages with enhanced flavors and aromas and to a method for preparing said beverages. Some embodiments of the invention consider soluble coffee and methods for preparing soluble coffee with enhanced qualities such as flavor and aroma.

The invention described in document U.S. Pat. No. 5,439,699A details a method for preparing a clear, colorless beer using a method that includes ultrafiltration and the addition of dextrins, bittering agents and a foam enhancer. Also described are methods for preparing improved non-alcoholic malt beverages and making natural beer foaming components. Methods are also described for preparing malt beverages with a flavoring, including a stable malt beverage with citrus flavoring.

The invention described in document WO2015037006A1 details an apparatus and a method for providing a cosmetic skin treatment which comprises a chemically active material in solid form, preferably in the form of a tablet, and a second material which is chemically reactive with the first material such that effervescence is produced during the reaction. The chemically active materials may be activated by a user to provide a cosmetic skin treatment. Activation releases effervescence which propels the granules of the material which react on the skin. The size of the granules reduces during the reaction, thus providing continuous skin smoothing.

The invention developed and described in this document began with observing and studying the complexity and the time taken to make prepared beverages, such as cocktails, and as well as reducing costs, to make it possible for anyone to be able to prepare complex beverages as easily as possible with no room for errors, and also to increase the places and circumstances in which a person is able to prepare a complex beverage with no knowledge whatsoever.

The technical details of the invention developed are described below.

### DETAILED DESCRIPTION OF THE INVENTION

The characteristic details of the flavored effervescent tablet for the preparation of instant beverages are clearly demonstrated in the following description.

The resulting tablet that is the object of this invention allows a flavored beverage to be obtained such that for example a mojito could be prepared to which rum, mineral water and the tablet are added.

The tablet eliminates any need for knowledge of cocktail making so that the consumer need only add a spirit/liquor, liquid base and the tablet. The tablet also makes it possible to offer and/or consume cocktails in places where previously this was difficult, for example on airline flights.

In developing the invention, the following problems were considered that needed to be solved:
1. Finding the optimal percentages of the ingredients to allow complete and homogeneous dissolution,
2. Finding the optimal humidity levels in the tablet (adding initial liquids and dehydration method) to allow a fast dilution time,
3. Finding the correct combination and proportion of flavorings (natural, artificial, oils) to allow the flavors to be appreciated independently and in a palate-friendly way in the prepared beverage,
4. Dehydration times and temperatures indicated to achieve functionality,
5. Formulation: finding the percentage indicated for a balance between solids and liquids,
6. Obtaining the proportions of essential oils in the beverage if required,
7. Developing a formulation that could be dissolved rapidly in liquids at a low temperature.

In addition to the above, the invention seeks to overcome deficiencies in the preparation of beverages, using the tablet according to the invention:
Cocktail making by a bartender: requires experience and knowledge, preparation time and a large number of ingredients,
Syrups: must be measured,
Powders such as Tang®: require a method for homogenizing the beverage.

Technical Development of the Invention

The invention consists of a non-alcoholic tablet (similar to Alka-Seltzer®, based on bicarbonate) which provides all the flavor profiles that a prepared beverage should have instantly, portably and without difficulty.

To ensure a reaction is created, first about 60% sodium bicarbonate was used, and a salt-flavored tablet was therefore obtained. Next, prototypes were produced by varying the percentage of this input (between 9% and 10%). In addition, to accelerate the reaction, ascorbic acid was incorporated in a smaller proportion than the citric acid.

Maltodextrin was used, which is an additive that functions as a bulking agent; prototypes were produced with different sweeteners such as standard sugar, powdered standard sugar, sugar glass, refined sugar, unrefined sugar, Stevia®, sorbitol, fructose 42, crystalline fructose and sucralose, all at different concentrations. Sorbitol was used as a humectant, sweetener, stabilizing agent and plasticizer.

To make the tablet visible, two types of dried mint, peppermint and spearmint, were incorporated, peppermint being chosen because as well as making both the tablet and the prepared beverage visible, said peppermint imparted a fresh, herby smell. The peppermint was incorporated in powdered form as, if added whole, the tablet became more fragile. Moreover, samples were produced using 1% Green 3 color in different proportions until a light color, emblematic of a mojito, was obtained as the initial prepared beverage.

To package the tablets, trilaminar packages are required which provide the product with a barrier against light, oxygen and humidity, as these are expressly intended for dehydrated products. It is therefore important to package the tablets immediately after the dehydration process as, on coming in contact with the environment, the consistency changes, becoming harder, and the dissolution time is affected.

A mixture of powders, liquids and oils pressed into the form of a tablet which can be dissolved in water and/or alcohol and provides a beverage (alcoholic/non-alcoholic) with a given flavor profile (mojito, etc.) The powders are pressed into the form of a tablet while maintaining the sensory characteristics (color, odor, flavor, appearance) of a traditional mojito.

The main object of the tablet is to optimize the preparation time of a cocktail or prepared beverage, reduce the cost and complexity of the preparation process, and reduce the necessary ingredients. The tablet is easy to access, the space required is reduced and said tablet can be carried anywhere. In addition, said tablet meets the objective of rapid dissolution despite its low percentage of sodium bicarbonate (to speed up the reaction, ascorbic acid is incorporated in a lower proportion than the citric acid), without the temperature being important, which promotes the homogeneity of the beverage.

Resulting Formulation.

Once the tests and the prototypes of the beverages were completed and the required result in terms of the flavor of said beverages and the preparation form was achieved, the following formulation was reached:

| Raw material | Percentage (%) |
|---|---|
| Standard sugar (C₁₂H₂₂O₁₁) | 18.5 to 30 |
| Maltodextrin 10 (C₆H₁₀O₅)n | 3.4 to 26.9 |
| Citric acid (C₆H₈O₇) | 9.85 to 11.90 |
| Sodium bicarbonate (NaHCO₃) | 9.7 to 9.90 |
| Ascorbic acid (C₆H₈O₆) | 8.0 to 9.5 |
| Sorbitol (C₆H₁₄O₆) | 1.8 to 2.2 |
| Ingredients for the beverage type | 10.24 to 47.29 |
| % humidity | 3.06% ± 0.2% |
| Dissolution time | 1 minute 30 seconds |

The amount of maltodextrin 10 is dependent on the “ingredients for the beverage type” component, which means that a smaller amount of maltodextrin 10 is required as more ingredients for the beverage type have to be added, or alternatively, the amount of maltodextrin 10 is increased if the ingredients for the beverage type reduce.

Examples of the Application of the Resulting Formulation.

As examples of the use of the formula obtained, the following applications are provided for obtaining beverages:
Mojito mocktail:

| Raw material | Percentage |
|---|---|
| Standard sugar | 30 |
| Maltodextrin 10 | 25.59 |
| Citric acid | 11.90 |
| Sodium bicarbonate | 9.85 |
| Ascorbic acid | 9.01 |
| Unrefined sugar | 8.00 |
| Sorbitol | 2.10 |
| Lemon flavor with herbs | 1.39 |
| Stevia | 0.85 |
| Herb tea extract | 0.80 |
| Dried peppermint | 0.30 |
| Lemon essential oil | 0.12 |
| 1% Green 3 color | 0.09 |
| TOTAL | 100% |

Coffee (vanilla):

| Raw material | Percentage |
|---|---|
| Soluble coffee | 20 |
| Dried skimmed milk | 19 |
| Standard sugar | 18.52 |
| Citric acid | 11.9 |
| Sodium bicarbonate | 9.85 |
| Ascorbic acid | 9.01 |
| Powdered vanilla flavor | 3.48 |
| Maltodextrin 10 | 3.44 |
| Vanilla extract | 2.4 |
| Sorbitol | 2.1 |
| Salt | 0.3 |
| TOTAL | 100% |

Orange soda:

| Raw material | Percentage |
|---|---|
| Standard sugar | 30 |
| Maltodextrin 10 | 26.89 |
| Citric acid | 11.9 |
| Sodium bicarbonate | 9.85 |
| Ascorbic acid | 9.01 |
| Unrefined sugar | 7 |
| Sorbitol | 2.1 |
| Natural orange flavoring | 1.82 |
| Stevia | 0.85 |
| Blood orange essential oil | 0.2 |
| Sweet orange essential oil | 0.2 |
| 1% Red 40 color | 0.09 |
| 1% Yellow 5 color | 0.09 |
| TOTAL | 100% |

The advantages of the formulation developed include the following points:
Preparation time
Elimination of ingredients
Waste reduction
Beverage standardization
Elimination of the need for cocktail making knowledge
Practicality of delivery form

Examples and Possible Uses.
Cocktail making (for example, mojito): the tablet gives flavor to the cocktail to be prepared,
   Because in this case the tablet contains;
      Essential oils standard and unrefined sugar, ascorbic acid, citric acid, natural flavorings, Stevia® and natural extracts, to add olfactory and taste characteristics, in order to replace the above-mentioned ingredients,
      With this tablet, the consumer need only add a liquid base (in the case of a mojito, mineral water), the suggested spirit/liquor and the tablet, as said tablet was developed to be dissolved in time and form in an alcoholic base.
Mocktails: the tablet helps in the preparation of non-alcoholic cocktails for people who are intolerant of or who for some reason cannot take alcohol but wish to drink a beverage that gives a flavor similar to a cocktail with alcohol.
Vitamin-rich beverages: the tablet could perform the function of a means of delivering vitamins and minerals via a prepared beverage, for example electrolytes, vitamin C, vitamin B, etc.
Soup: preparation of edible soups using the invention.
Sauces: instant sauces for foods.
Flavored shots or slugs: different types of prepared shots or slugs.
Prepared beverages: preparation of beverages such as aguas frescas.
Sodas: preparation of low-calorie carbonated beverages.
General application for water-soluble products.

Production Method.

The production method for the flavored effervescent tablet for the preparation of instant beverages consists of the following steps:
1) Raw material reception: reception of the raw materials must be in a clean area to prevent contamination and include the following steps:
   a) The packages must be checked to ensure their integrity and cleanliness, rejecting any that show signs of contamination or production faults,
   b) Dry raw materials must be checked, rejecting those that show damage such as molds, unusual coloration or unpleasant odor, or that have passed their expiry date, as the case may be; said dry raw materials should be stored in a cool, dry place,
   c) Work areas, equipment and utensils must be clean and free from any organic material, washed with running water and soap and a citrus-based sanitizer should then be used, in this case Citrogen®, which is a natural preservative obtained from grapefruit seed extract at a concentration of 0.5 mL/L water,
2) Ingredient weighing: the ingredients are weighed separately taking account of the percentages indicated in the formulation,
3) Premixing: the powders are ground to obtain finer and more homogeneous particles so that the inputs are appropriately incorporated and compressed,
4) Addition of liquid inputs: the liquid inputs (colorants, flavorings and sorbitol) are added, stirring continuously until a homogeneous mixture is obtained,
5) Dosing: the mass obtained is supplied at 7.5 grams per tablet,
6) Pressing: the dosed mass is placed in molds and pressed,
7) Dehydration: the tablets formed are placed in a tray dehydrator using hot air at a temperature of 35° C.±2° C. for 20 minutes,
8) Packaging: the tablets are individually packaged in trilaminar pouches,
9) Labelling and batching: the product is labelled and batched taking account of the corresponding regulations, to ensure suitable product identification and traceability,
10) Warehousing: the product is stored in a cool, dark, dry place at ambient temperature (20° C.-25° C.); once opened said product must be consumed immediately as it may absorb humidity from the environment and react.

The above description of the definitions disclosed are provided to allow a person skilled in the art to make or use the present invention. Various changes to these definitions and/or implementations will be obvious to persons skilled in the art and the generic principles defined here may be applied to other embodiments without departing from the spirit or scope of the invention. Thus, the present invention is not intended to be limited to the embodiments shown in this document, but should be accorded the widest scope consistent with the following claims and the principles and novel characteristics described herein.

What is claimed is:

1. Flavored effervescent tablet for the preparation of instant beverages for human consumption, characterized in that it comprises the following ingredients:

| Raw material | Percentage (%) |
|---|---|
| Standard sugar (C₁₂H₂₂O₁₁) | 18.5 to 30 |
| Maltodextrin 10 (C₆H₁₀O₅)n | 3.4 to 26.9 |
| Citric acid (C₆H₈O₇) | 9.85 to 11.90 |
| Sodium bicarbonate (NaHCO₃) | 9.7 to 9.90 |
| Ascorbic acid (C₆H₈O₆) | 8.0 to 9.5 |
| Sorbitol (C₆H₁₄O₆) | 1.8 to 2.2 |
| Ingredients for type of beverage | 10.24 to 47.29 |

2. Flavored effervescent tablet for the preparation of instant beverages for human consumption according to claim 1, also comprising:

| | |
|---|---|
| % humidity | 3.06% ± 0.2% |
| Dissolution time | 1 minute 30 seconds |

3. Flavored effervescent tablet for the preparation of instant beverages for human consumption according to claim 1 wherein the amount of maltodextrin 10 is dependent on the ingredients for the beverage type, which means that a smaller amount of maltodextrin 10 is required as more ingredients for the beverage type have to be added, or alternatively, the amount of maltodextrin 10 is increased if the ingredients for the beverage type reduce.

4. Use of a flavored effervescent tablet for the preparation of instant beverages for human consumption according to claim 1, in:
a. Cocktail making: the tablet gives flavor the cocktail to be prepared,
b. Mocktails: the tablet helps in the preparation of non-alcoholic cocktails for people who are intolerant of or who for some reason cannot take alcohol but wish to drink a beverage that gives a flavor similar to a cocktail with alcohol,
c. Vitamin-rich beverages: the tablet could perform the function of a means of delivering vitamins and minerals via a prepared beverage, for example electrolytes, vitamin C, vitamin B, etc.,
d. Soups: preparation of edible soups with the invention,
e. Sauces: instant sauces for foods,
f. Flavored shots or slugs: different types of prepared shots or slugs,
g. Prepared beverages: preparation of beverages such as aguas frescas,
h. Sodas: preparation of low-calorie carbonated beverages,
i. General application for water-soluble products.

5. Production method for a flavored effervescent tablet for the preparation of instant beverages for human consumption, comprising the following steps:
a. Raw material reception: reception of the raw materials must be in a clean area to prevent contamination and include the following steps:
i. The packages must be checked to ensure their integrity and cleanliness, rejecting any that show signs of contamination of production faults,
ii. Dry raw materials must be checked, rejecting those that show damage such as molds, unusual coloration or unpleasant odor, or have passed their expiry date, as the case may be; said dry raw materials should be stored in a cool, dry place,
iii. Work areas, equipment and utensils must be clean and free from any organic material, washed with running water and soap and a citrus-based sanitizer should then be used,
b. Ingredient weighing: the ingredients are weighed separately taking account of the percentages indicated in the formulation,
c. Premixing: the powders are ground to obtain finer and more homogeneous particles so that the inputs are appropriately incorporated and compressed,
d. Addition of liquid inputs: the liquid inputs (colorants, flavorings and sorbitol) are added, stirring continuously until a homogeneous mixture is obtained,
e. Dosing: the mass obtained is supplied at 7.5 grams per tablet,
f. Pressing: the dosed mass is placed in molds and pressed,
g. Dehydration: the tablets formed are placed in a tray dehydrator using hot air at a temperature of 35° C.±2° C. for 20 minutes,
h. Packaging: the tablets are individually packaged in trilaminar pouches,
i. Labelling and batching: the product is labelled and batched taking account of the corresponding regulations, to ensure suitable product identification and traceability,
j. Warehousing: the product is stored in a cool, dark, dry place at ambient temperature (20° C.-25° C.); once opened said product must be consumed immediately as the product may absorb humidity from the environment and react.
